(19) United States
(12) Patent Application Publication
(10) Pub. No.: US 2017/0151882 A1
(43) Pub. Date: Jun. 1, 2017

(54) SELF-PROPELLED BATTERY MODULE AND ELECTRIC VEHICLE

(71) Applicant: HON HAI PRECISION INDUSTRY CO., LTD., New Taipei (TW)

(72) Inventor: CHIA-YEN LEE, New Taipei (TW)

(21) Appl. No.: 14/984,366

(22) Filed: Dec. 30, 2015

(30) Foreign Application Priority Data
Nov. 30, 2015 (TW) 104140010

(51) Int. Cl. B60L 11/18

(52) U.S. Cl. CPC B60L 11/1822; B60L 11/18; B60L 11/1809

(57) ABSTRACT

A self-propelled battery module configured to detachably mounted on an electric vehicle includes a rechargeable battery and a travelling controller assembled together with the rechargeable battery. The rechargeable battery is configured to supply electric power to the electric vehicle. The travelling controller includes a control unit, a driving unit electrically connected to the control unit, and a travelling wheel connected to the driving unit. The control unit is configured to transmit a control signal to the driving unit, and the driving unit is configured to receive the control signal from the control unit and drive the travelling wheel to rotate, and the self-propelled battery is capable of moving automatically.

### FIELD

The subject matter herein generally relates to a battery for an electric vehicle, and particularly, to a self-propelled battery module and an electric vehicle including the self-propelled battery module.

### BACKGROUND

Battery pack is configured to supply power to motor of an electric vehicle. When the amount of charge of the battery pack is less than or equal to a predetermined amount, the battery pack needs to charged while remaining in the vehicle, or the spent battery pack needs to be replaced by a fully charged battery.

### BRIEF DESCRIPTION OF THE DRAWINGS

Implementations of the present technology will now be described, by way of example only, with reference to the attached figures.

FIG. 1 is a diagrammatic view of one example of an electric vehicle.

FIG. 2 is a diagrammatic view of a self-propelled battery module shown in FIG. 1.

FIG. 3 is a block diagram of the self-propelled battery module as shown in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as coupled, whether directly or indirectly through intervening components, and is not necessarily limited to physical connections. The connection can be such that the objects are permanently coupled or releastably coupled. The term “comprising” when utilized, means “including, but not necessarily limited to”; it specifically indicates open-ended inclusion or membership in the so-described combination, group, series and the like.

The present disclosure is described in relation to a self-propelled battery module and an electric vehicle including the self-propelled battery module.

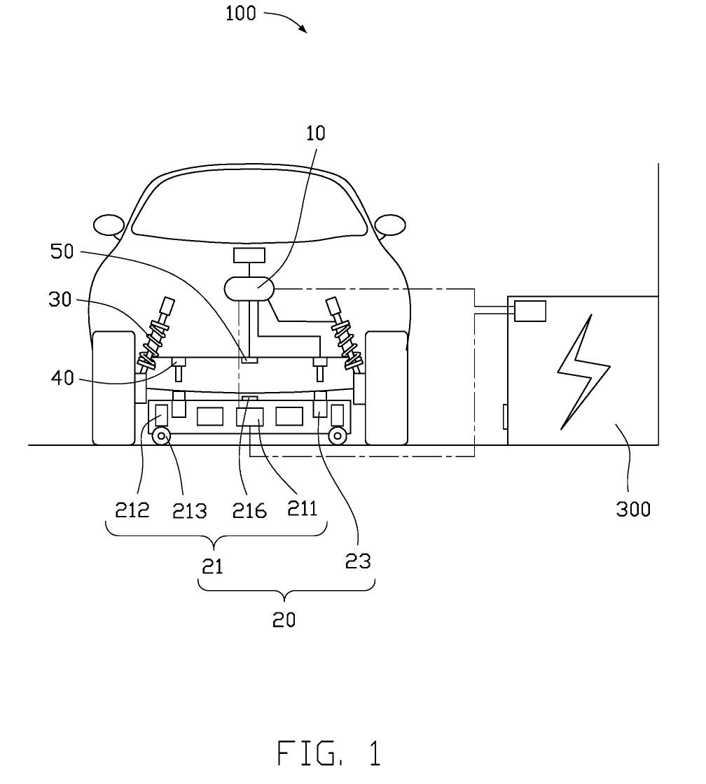

FIG. 1 illustrates that an electric vehicle 100 can include a control system 10, a self-propelled battery module 20, a ride-height adjuster 30, a battery fixing member 40, and a vehicle positioning module 50. The ride-height adjuster 30, the battery fixing member 40, and the vehicle positioning module 50 can be electrically connected to the control system 10. The control system 10 can be in communication with the self-propelled battery module 20. In at least one embodiment, the control system 10 can establish a wireless link with the self-propelled battery module 20.

The self-propelled battery module 20 can be detachably mounted on the electric vehicle 100 by the battery fixing member 40. The self-propelled battery module 20 can be mounted below a chassis of the electric vehicle 100. When the electric vehicle 100 is driven adjacent to a charging station 300, the self-propelled battery module 20 can move automatically between the electric vehicle 100 and the charging station 300. The self-propelled battery module 20 can include a travelling controller 21 and a battery module connecting member 23. The battery module connecting member 23 can be coupled to the battery fixing member 40, thereby the self-propelled battery module 20 can be fixed to the electric vehicle 100.

The ride-height adjuster 30 can be controlled by the control system 10 and configured to automatically adjust the ride height of the electric vehicle 100. When detaching the self-propelled battery module 20, the rid-height adjuster 30 can raise the vehicle body relative to the ground. When mounting the self-propelled battery module 20, the rid-height adjuster 30 can lower the vehicle body. The ride-height adjuster 30 can include a pneumatic suspension system or a hydraulic suspension system, and the height of the vehicle body can be adjusted by the pneumatic/hydraulic suspension system. In other embodiments, the ride-height adjuster 30 can be other driving mechanism adapter for vehicle.

The battery fixing member 40 can be controlled by the control system 10 and configured to couple the self-propelled battery module 20, thereby the self-propelled battery module 20 can be mounted on the electric vehicle body or disassembled from the electric vehicle body.

The vehicle positioning module 50 can be configured to sense if the self-propelled battery 20 is located below the electric vehicle 100, and send a sensing signal to the control system 10. The control system 10 can control the battery fixing member 40 to connect with the self-propelled battery 20 after receiving the sensing signal.

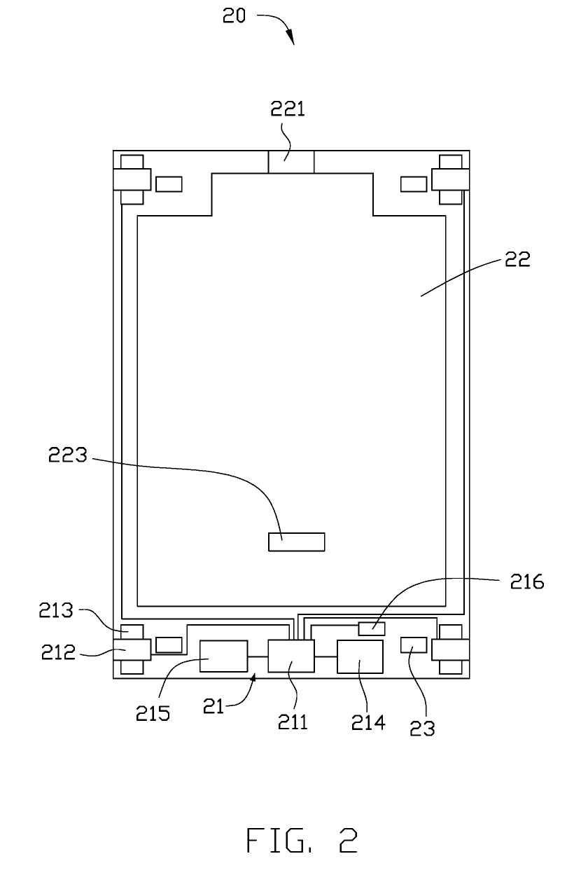

FIG. 2 illustrates that the self-propelled battery module 20 can further include a rechargeable battery 22 assembled together with the travelling controller 21. The rechargeable battery 22 can be configured to supply electric power to the electric vehicle 100. The rechargeable battery 22 can couple with a battery controlling system (not shown) in the electric vehicle 100. The rechargeable battery 22 can include a charge interface 221 and a power supply interface 223. The charge interface 221 can be coupled to a charging interface (not shown) of the charging station 300, and the power supply interface 223 can be coupled to the battery controlling system in the electric vehicle 100.

The battery connecting member 23 can number four, and the four battery connecting members 23 can be positioned at four corners of the self-propelled battery module 20.

The travelling controller 21 can include a control unit 211, a driving unit 212, a travelling wheel 213, a battery unit 214, a sensing unit 215, and a positioning unit 216. The driving unit 212, the battery unit 214, the sensing unit 215, and the positioning unit 216 can be electrically connected to the control unit 211.

In at least one embodiment, the travelling wheel 213 can number four, and the four travelling wheels 213 are positioned at four corners of the self-propelled battery module 20. The driving unit 212 also numbers four, and each driving unit 212 can be electrically connected to the control unit 211. The travelling wheel 213 can be wheel type or crawler-type, and the driving unit 212 can be any driving mechanism adapted for driving the travelling wheel 213.

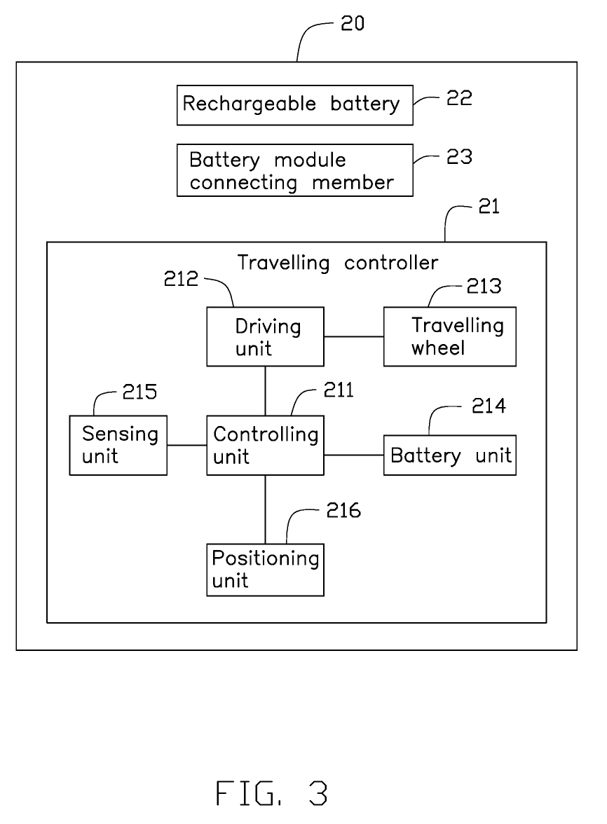

FIG. 3 illustrates that the travelling wheel 213 can be connected to the corresponding driving unit 212.

The control unit 211 can storage route data of the charging station 300. The sensing unit 215 can be configured to transmit and receive sound ranging signal for distance measuring, and feedback a distance signal to the control unit 211. Thus, a distance between the self-propelled battery module 20 in the charging station 300 and the electric vehicle 100 adjacent to the charging station 300 can be measured. The control unit 211 can calculate the distance signal from the sensing unit 215 based on the existing route data for real time routing optimization. Then, the control unit 211 can obtain an optimized route and then transmit an optimized route signal and electric power to the driving unit 212.

The driving unit 212 can be configured to receive the optimized route signal from the control unit 211 and drive the travelling wheel 213, thus the self-propelled battery module 20 can move following the optimized route.

The positioning unit 216 can be configured to measure a position deviation between the self-propelled battery module 20 and the electric vehicle 200, and transmit a signal of the position deviation to the control unit 211. The control unit 211 can transmit the signal of the position deviation to the driving unit 212, and the travelling wheel 213 can rotate to adjust the location of the self-propelled battery module 20, thereby the self-propelled battery module 20 can move to a precise position below the electric vehicle 100.

The battery unit 214 can supply electric power to the driving unit 212 through the control unit 211.

In replacing the self-propelled battery module 20, the user can drive the electric vehicle 100 to the charging station 300 and input a replacing signal to the control system 10. The ride-height adjuster 30 can raise the ride height of the electric vehicle 100, and the battery fixing member 40 can unlock the self-propelled battery module 20 which is weak and release the self-propelled battery module 20 on the ground. Then, the weak self-propelled battery module 20 can move automatically toward the charging station 300 controlled by the control system 10, and the weak self-propelled battery module 20 can be charged in the charging station 300.

The control system 10 can transmit a starting signal to a fully-charged self-propelled battery module 20 in the charging station 300. The sensing unit 215 of the fully-charged self-propelled battery module 20 can measure the distance between the self-propelled battery module 20 and the electric vehicle 100, and send the distance signal to the control unit 211. The control unit 211 can calculate the signal from the sensing unit 215 based on the existing route data to obtain an optimized route, and transmit the optimized route date to the driving unit 212. The travelling wheel 213 can rotate automatically to the electric vehicle 100 driven by the driving unit 212.

The sensing unit 216 can measure the position deviation between the self-propelled battery module 20 and the electric vehicle 100, and transmit the signal of the position deviation to the control unit 211. The control unit 211 can transmit the signal of the position deviation to the driving unit 212, thus the travelling wheel 213 can move until the self-propelled battery module 20 aligns with to the chassis of the electric vehicle 100. After the control system 10 verifies the self-propelled battery module 20 is located, the control system 10 can transmit a control signal to the battery fixing member 23, and the battery fixing member 23 can couple with the self-propelled battery module 20, thereby the self-propelled battery module 20 can be mounted on the electric vehicle 100. The recharge battery 22 can supply electric power to the electric vehicle, and then the ride-height adjuster 30 can lower the ride height to the initial state controlled by the control system 10.

In other embodiments, the battery connecting member 23 can be omitted, and the self-propelled battery module 20 can be clamped by the battery fixing member 40.

In other embodiments, the travelling wheel 213 can number one, two, three, or more, as long as the self-propelled battery module 20 can move smoothly.

The self-propelled battery module 20 can move automatically to the charging station 300 or other charging facility, and the self-propelled battery module 20 can move automatically to the electric vehicle 100. There is no need to build special swapping facility. The electric vehicle 100 can replace the recharge batteries quickly and with high automatization. Moreover, the recharge battery 22 of the self-propelled battery module 20 can be replaced with different kinds of batteries to meet demand of different kinds of electric vehicles, and the self-propelled battery module 20 can be widely used.

The embodiments shown and described above are only examples. Many details are often found in the art such as the other features of a self-propelled battery module and an electric vehicle. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A self-propelled battery module configured to be detachably mounted on an electric vehicle, the self-propelled battery module comprising:
a rechargeable battery configured to supply electric power to the electric vehicle; and
a travelling controller assembled together with the rechargeable battery, the travelling controller comprising:
a control unit;
a driving unit electrically connected to the control unit; and
a travelling wheel connected to the driving unit;
wherein the control unit is configured to transmit a control signal to the driving unit, and the driving unit is configured to receive the control signal from the control unit and drive the travelling wheel to rotate, and the self-propelled battery is capable of moving automatically.

2. The self-propelled battery module as claimed in claim 1,
wherein the self-propelled battery module further comprises a positioning unit, the positioning unit is configured to detect a position deviation between the self-propelled battery module and the electric vehicle, and transmit a signal of the position deviation to the control unit; and
wherein the control unit is further configured to transmit the signal of the position deviation to the driving unit.

3. The self-propelled battery module as claimed in claim 1, wherein the self-propelled battery module further comprises a sensing unit, and the sensing unit is configured to measure a distance between the self-propelled battery module and the electric vehicle, and transmit a distance signal to the control unit.

4. The self-propelled battery module as claimed in claim 3, wherein the control unit storage route data, the control unit is further configured to process the distance signal based on the route data to obtain an optimized route, and transmit an optimized route signal to the driving unit.

5. The self-propelled battery module as claimed in claim 1, wherein the self-propelled battery module further comprises a battery unit electrically connected to the control unit, and the battery unit is configured to supply electric power to the driving unit through the control unit.

6. The self-propelled battery module as claimed in claim 1, wherein the self-propelled battery module further comprises a battery module connecting member, the battery module connecting member is configured to couple with the electric vehicle to fix the self-propelled battery module to the electric vehicle.

7. The self-propelled battery module as claimed in claim 1,
wherein the driving unit numbers four, and the travelling wheel numbers four; and
wherein each driving unit is electrically connected to the control unit, and each travelling wheel is connected to the corresponding driving unit.

8. An electric vehicle, comprising:
a control system, and
a self-propelled battery detachably mounted on the electric vehicle and establishes a wireless link with the control system, the self-propelled battery comprising:
a rechargeable battery configured to supply electric power to the electric vehicle; and
a travelling controller assembled together with the rechargeable battery, the travelling controller comprising:
a control unit;
a driving unit electrically connected to the control unit; and
a travelling wheel connected to the driving unit;
wherein the control unit is configured to transmit a control signal to the driving unit, and the driving unit is configured to receive the control signal from the control unit and drive the travelling wheel to rotate, and the self-propelled battery is capable of moving automatically.

9. The electric vehicle as claimed in claim 8, wherein the electric vehicle further comprises a ride-height adjuster electrically connected to the control system, and the ride-height adjuster is configured to adjust a ride height of the electric vehicle controlled by the control system.

10. The electric vehicle as claimed in claim 8, wherein the electric vehicle further comprises a vehicle positioning module electrically connected to the control system, and the vehicle positioning module is configured to configured to sense if the self-propelled battery located below the electric vehicle, and send a sensing signal to the control system.

11. The electric vehicle as claimed in claim 8, wherein the electric vehicle further comprises a battery fixing member electrically connected to the control system.

12. The electric vehicle as claimed in claim 8, wherein the self-propelled battery module further comprises a positioning unit, the positioning unit is configured to measure a position deviation between the self-propelled battery module and the electric vehicle, and transmit a signal of the position deviation to the control unit; and
wherein the control unit is further configured to transmit the signal of the position deviation to the driving unit.

13. The electric vehicle as claimed in claim 8, wherein the self-propelled battery module further comprises a sensing unit, and the sensing unit is configured to measure a distance between the self-propelled battery module and the electric vehicle, and transmit a distance signal to the control unit.

14. The electric vehicle as claimed in claim 13, wherein the control unit storage route data, the control unit is further configured to process the distance signal and the route data to obtain an optimized route, and transmit an optimized route signal to the driving unit.

15. The electric vehicle as claimed in claim 8, wherein the self-propelled battery module further comprises a battery unit electrically connected to the control unit, and the battery unit is configured to supply electric power to the driving unit through the control unit.

16. The electric vehicle as claimed in claim 8, wherein the self-propelled battery module further comprises a battery module connecting member, and the battery module connecting member is configured to couple with the electric vehicle to fix the self-propelled battery module to the electric vehicle.

17. The electric vehicle as claimed in claim 8,
wherein the driving unit numbers four, and the travelling wheel numbers four; and
wherein each driving unit is electrically connected to the control unit, and each travelling wheel is connected to the corresponding driving unit.
